(19) United States
(12) Patent Application Publication
(10) Pub. No.: US 2018/0358839 A1
(43) Pub. Date: Dec. 13, 2018

(54) Multi-Function Energy Station

(71) Applicant: S&C Electric Company, Chicago, IL (US)

(72) Inventors: Marcelo A. Perez, New Berlin, WI (US); Marshall Mauney, West Bend, WI (US)

(73) Assignee: S&C Electric Company, Chicago, IL (US)

(21) Appl. No.: 15/993,727

(22) Filed: May 31, 2018

Related U.S. Application Data
(60) Provisional application No. 62/518,414, filed on Jun. 12, 2017.

(51) Int. Cl. H02J 9/06; G05B 15/02; H02J 3/38; H02J 3/32; B60L 11/18

(52) U.S. Cl. CPC H02J 9/061; G05B 15/02; B60L 11/1824; H02J 3/386; H02J 3/32; H02J 3/383

(57) ABSTRACT

An electrical power distribution network that is able to provide power to a plurality of loads, such as electric vehicle charging stations, on demand. The network includes a DC bus and a plurality of power sources that may be a number of renewable energy power sources, such as an array of photovoltaic (PV) cells and wind turbines, and a number of energy storage devices, such as batteries, that are electrically coupled to the DC bus. The network also includes a DC-to-AC power conversion system (PCS) that is electrically coupled to the DC bus and an AC utility feed line that is part of an electrical grid. The network further includes a system controller that controls which of the power sources and the utility grid provides power to the loads in response to a power demand from the loads and the available power from the power sources and the grid.

### CROSS-REFERENCE TO RELATED APPLICATION

This application claims the benefit of the filing date of U.S. Provisional Patent Application Ser. No. 62/518,414, titled Multi-Function Energy Station, filed Jun. 12, 2017.

### BACKGROUND

### Field

The present disclosure relates generally to an electrical power distribution network that includes a plurality of integrated power sources that combine to provide power to a plurality of loads on demand and, more particularly, to an electrical power distribution network that includes a plurality of integrated power sources coupled to a common DC bus and a DC-to-AC power conversion system (PCS) coupled to the DC bus and an AC utility feed line that is part of a utility grid that combine to provide power to a plurality of loads on demand.

### Discussion of the Related Art

An electrical power distribution network, often referred to as an electrical grid, typically includes a number of power generation plants each having a number of power generators, such as gas turbine engines, nuclear reactors, coal-fired generators, hydro-electric dams, etc. The power plants provide a high voltage AC signal on high voltage transmission lines that deliver electrical power to a number of substations typically located within a community, where the voltage is stepped down to a medium voltage. The substations provide the medium voltage power to a number of three-phase feeder lines. The feeder lines are coupled to a number of lateral lines that provide the medium voltage to various transformers, where the voltage is stepped down to a low voltage and is provided to a number of loads, such as homes, businesses, etc.

These types of power distribution networks are usually designed to provide a certain amount of power to particular areas in the network to support the loads in that area, where the amount of power demanded by the loads is usually consistent and predictable and does not significantly vary from time to time. In other words, the number, size, etc. of the various lines, switches, transformers, etc. are selected and designed to provide a certain amount of maximum power, where if that amount of power is exceeded, breakers will be tripped to prevent the system from being overloaded.

Electric vehicles (EVs) are quickly becoming one of the largest loads on the US electrical grid, and thus the management of the electrical load created by EV charging stations is becoming a significant challenge to electrical utilities. For example, certain locations, such as remote charging facilities, office buildings, malls, etc., may in the near future include many vehicle charging stations, where each station may be equipped to charge an EV relatively quickly, which causes a significant load to be created on the network. If a large number of the charging stations are being used at any particular point in time, especially if they are charging the vehicles relatively quickly, then the maximum power draw on the network may be exceeded. In other words, if a particular location in a power distribution network is designed to provide a certain amount of power, building a large number of vehicle charging stations at that location may cause the ability of the network to meet the power demands for that location to be exceeded. Currently, it would be necessary to increase the capacity of the network infrastructure to meet such high power demands at a particular location, which would likely be very costly.

### SUMMARY

The following discussion discloses and describes an electrical power distribution network that is able to provide power to a plurality of loads, such as electric vehicle charging stations, on demand. The network includes a DC bus and a plurality of integrated power sources that may be a number of renewable energy power sources, such as an array of photovoltaic (PV) cells and wind turbines, and a number of energy storage devices, such as batteries, that are electrically coupled to the DC bus. The network also includes a DC-to-AC power conversion system (PCS) that is electrically coupled to the DC bus and an AC utility feed line that is part of an electrical grid. The network further includes a system controller that controls which of the power sources and the utility grid provides power to the loads in response to a power demand from the loads and the available power from the power sources and the grid. The controller can prioritize which of the power sources provides power to the loads at any particular time so as to optimize efficiency and reduce cost.

Additional features of the disclosure will become apparent from the following description and appended claims, taken in conjunction with the accompanying drawings.

### BRIEF DESCRIPTION OF THE DRAWING

FIG. 1 is a simplified schematic illustration of an electrical power distribution network including multiple power sources.

### DETAILED DESCRIPTION OF THE EMBODIMENTS

The following discussion of the embodiments of the disclosure directed to an electrical power distribution network that includes a plurality of integrated power sources that provide power to a plurality of loads on demand is merely exemplary in nature, and is in no way intended to limit the invention or its applications or uses.

It is anticipated that as the number of EVs increases, the maximum total vehicle charging demand load may exceed the capacity of any single power source, with the possible exception of the distribution utility connection. As will be discussed in detail below, this disclosure proposes a power system that includes a combination of advanced controls, energy storage systems and renewable energy sources that operate to not only reduce the load on the utility grid created by EV charging stations, but also provide support for the voltage, frequency and capacity of the utility grid, where the power system provides an effective way of integrating the EV charging stations, the energy storage system and the renewable energy sources. The power system thus employs a number of highly integrated components including energy storage systems, EV chargers, photovoltaic (PV) cells, wind generators, a system controller and auxiliary generators with DC-to-DC and DC-to-AC bi-directional power conversion systems (PCS) to provide high efficiency and low cost to perform a variety of applications for the community and the grid that the system is connected to.

The power system also employs a common high-capacity DC bus that minimizes the conversion from DC to AC and provides the ability to aggregate and combine the multiple power sources without the need for frequency synchronization. The common DC bus allows the multiple power sources to be connected and disconnected as necessary in response to dynamic changes in both the load and source capacity. Therefore, the control system will necessarily be capable of maintaining voltage matching between the various power sources.

The power system described herein can perform a number of functions including:
EV charging, where the power system can charge the electric vehicles from the power source that is the most economic at the time of charging, and where the system controller has the ability to decide what power source or combination of power sources to use to achieve the most economical result;
electric vehicle to grid/micro-grid energy supply, where in the event of a utility failure or when the local power demand exceeds the grid capacity, the energy from the vehicle batteries can be directed to the grid;
electric energy time-shifting (arbitrage), where purchasing inexpensive electric energy, available during periods when prices or system marginal costs are low, to charge the energy storage system so that the stored energy can be used or sold at a later time when the price or costs are high;
real-time calculation of net delivered energy cost to be used for localized pricing of EV charging energy;
real-time calculation of net delivered energy cost to be used for determination of grid support decisions;
electric supply capacity regulation that defers and/or reduces the need to buy new central station generation capacity and/or purchasing capacity in the wholesale electricity marketplace;
frequency regulation that manages interchange flows with other control areas to closely match the scheduled interchange flows and momentary variations in demand within the control area;
spinning, non-spinning and supplemental reserve generation and storage capacity that can be called upon when some portion of the normal electric supply resources become unavailable unexpectedly, which may be online but unloaded, offline but available within 10 minutes or available within 1 hour;
voltage/VAR support to maintain the voltage within specified limits;
black-start that brings the system on-line after a catastrophic failure of the grid;
protection functions that will disconnect the system or a portion thereof from the inverter output upon detection of an electrical fault;
protection functions that will disconnect the system or a portion thereof from the utility grid upon detection of an electrical fault;
renewable smoothing that dampens the variability of wind and PV systems and load following/ramping support for renewables;
improved frequency response that is similar to frequency regulation, except that it reacts to system needs in even shorter time periods of seconds to less than a minute when there is a sudden loss of a generation unit or a transmission line frequency response;
transmission/distribution upgrade deferral that delays, and in some cases avoids entirely, utility investments in transmission system upgrades;
transmission congestion relief that discharges during peak demand periods to reduce peak transmission capacity requirements;
power reliability to support customer loads when there is a total loss of power from the source utility;
peak shaving/demand charge management that reduces the end users overall costs for electric service by reducing their demand during peak periods specified by the utility;
islanding that allows disconnecting the power system from the grid or starting in black-start; and
remote control where the power system can receive commands from the utility to perform any of the functions via the communications network.

The power system could incorporate voltage and flow-based interconnection relay controls that operate similar to “network protectors” that use a voltage differential between a common low voltage power distribution bus and multiple power sources to connect or disconnect the power sources to balance the loads and prevent unintended backflow from one power source to another. This approach would also provide a secondary benefit of providing a point of system and safety protection by rapidly removing any connected source or segment that exhibits a high load, low impedance, or other characteristic of a faulted conductor.

The power system may be implemented so as to maximize the use of renewable power sources and minimize the use of energy from the external power distribution grid, with particular emphasis on the reduction of peak power demand. The control system could be configured to prioritize the use of the power sources so as to reduce cost and increase efficiency by using as much power as is available from a predetermined highest priority power source connected to the bus. When the system load from the vehicle chargers and secondary loads exceed the available power from the highest priority source, the control system can connect a second-highest priority power source to the bus. If the demand exceeds the combined available power from those power sources, a next highest priority power source can be connected to the bus and subsequent lower priority power sources can be connected in a descending priority order as the total system power demand increases. There may also be a need for a significant amount of hysteresis to be built into the control scheme to avoid excessive switching operations. The priority of one configuration of power sources could be in the order of a solar array, wind turbine, battery storage, utility feed and back-up generator. However, it is noted that some power systems could incorporate multiple power sources of each type, i.e., several individual wind turbines or multiple utility feeds. It is further noted that the prioritization of the power sources may change dynamically based on several factors, including, but not limited to, utility rate structure, particularly where a time-of-use rate structure is in place, state of charge of energy storage batteries, current charging demand, time of day, and volt/VAR or frequency support requests from the distribution utility.

While the intent of the power system is to provide multiple high-rate charging stations, it is foreseeable that the power system may incorporate variable charging rates both as a total system and for individual charging stations. Charge rate controls may be applied to enact pricing structure, enable load management, or due to a combination of factors. For example, pricing for vehicle charging energy may be variable, for example, based on charging rate, or charging price/rate structures may be determined by power source availability or retail time-of-use energy pricing.

Additionally, the power system may not always be able to provide the maximum charging rate at each and every charging station due to multiple factors, including, but not limited to, insufficient aggregate source capacity, load shed commands from the utility, volt/VAR or frequency support requests from utility, peak demand minimization, instantaneous pricing from the utility being excessively high, and the unavailability of fuel for backup generation. In response to an insufficient power source capacity situation, the power system will need to have the capability to slow vehicle charging rates so that the load is managed to a level within the power source availability. Vehicle charging load may be level across all of the charging stations, or may be distributed based on desired rates at varying prices paid by individual users.

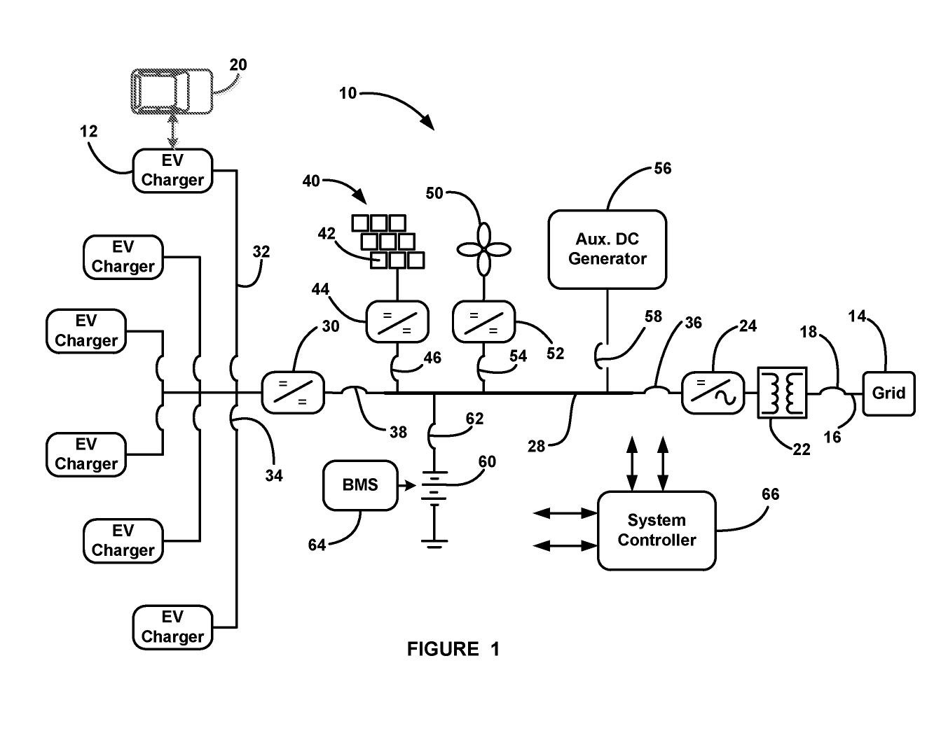

A power system of the type discussed above can be configured in many different ways. FIG. 1 is a simplified schematic type diagram of an electrical power distribution network 10 that is one non-limiting example of such a power system that provides power from a common DC bus 28 to a plurality of loads, depicted here as EV charging stations 12 for charging batteries within electric vehicles 20. It is noted that providing power to the charging stations 12 is by way of example in that the network 10 can be configured to provide power to other types of loads including a configuration of different types of loads. The network 10 is electrically coupled to an electrical power grid 14 operated by, for example, a utility on line 16 and can be disconnected therefrom by a switch 18. The network 10 can be considered a micro-grid that can be islanded, i.e., provide its own power separate from the grid 14, where a micro-grid typically includes one or more power sources, such as photovoltaic cells, diesel generators, battery modules, wind farms, etc. In this manner, the network 10 can be disconnected from the grid 14 in the event of a fault or some other condition occurring in the grid 14, where the various power sources in the network 10 can then support the loads in the network 10. During normal operation, the power sources may be reducing the amount of power that the loads in the network 10 are drawing from the grid 14, or may be placing power onto the grid 14. It is noted that the several components of the network 10 discussed herein are all in the general vicinity of each other.

The network 10 is connected to the power grid 14 through a transformer 22 that steps the medium voltage down from the grid 14 to a lower power level suitable for providing power to the charging stations 12. An AC-to-DC bi-directional power conversion system (PCS) 24 that includes an inverter for converting the AC power from the grid 14 to DC power that is provided on the DC bus 28. Likewise, the PCS 24 converts DC power from the network 10 to AC power that is placed on the grid 14 during those times when the network 10 is generating more power than it is using. A DC-to-DC PCS 30 is provided on the bus 28 that conditions and typically steps down the voltage on the DC bus 28 to be suitable for the number and type of the charging stations 12 that may be drawing power at any particular point in time, where the conditioned DC power is distributed to the charging stations 12 on a number of lines 32, and where each line 32 includes a normally closed switch 34. Normally closed switches 36 and 38 are provided in the bus 28 between the PCSs 24 and 30 for failure and safety purposes.

The network 10 includes a number of integrated power sources that provide power on the bus 28 and in combination with the power provided on the grid 14 allow the power demands from the charging stations 12 to be met, which may be significant at any particular point in time. In this non-limiting illustration, the network 10 includes an array 40 of solar panels or photovoltaic (PV) cells 42 that provide DC power to the bus 28 through a DC-to-DC PCS 44 and a normally closed circuit breaker 46. The network 10 also includes a wind turbine 50 that provides DC power to the bus 28 through a DC-to-DC PCS 52 and a normally closed breaker 54. An auxiliary DC generator 56, such as a diesel generator, is also electrically coupled to the bus 28 through a normally open circuit breaker 58. The generator 56 acts as a back-up power source in the event that the other power sources in the network 10 are unable to meet the demand of the charging stations 12, such as during low sun and low wind periods. An energy storage device, shown here as a battery module 60, is electrically coupled to the bus 28 through a normally closed circuit breaker 62 and is also available to provide power to the charging stations 12 when necessary. The battery module 60 is controlled by a battery management system (BMS) 64 that controls the voltage level of the battery cells therein and can operate the module 60 between a charge and a discharge mode depending on the amount of power that is available to power the charging stations 12.

A system controller 66 employs a combination of hardware and software that controls the various devices, systems and components in the network 10 to control the amount and type of power provided to or from the various power sources described above based on the particular functionality that needs to be performed at any particular point in time. In other words, the controller 66 determines what the power demand is from the charging stations 12 and what the availability of power is from the power sources and uses that power to satisfy the demand based on a certain power control scheme. For example, the controller 66 controls whether the battery module 60 is being charged or discharged, what power source is charging the battery module 60, whether the network 10 is drawing power from the grid 14 or placing power on the grid 14, providing frequency regulation of the power signals on the grid 14, providing voltage support for the grid 14, optimizing the use of the energy from the power sources, determining what type of energy to provide, connecting/disconnecting the PCSs 24, 44 and 52 to the bus 28 and regulating power flow. The network 10 can be controlled depending on available power and power demand from the charging stations 12 to use the grid 14 to charge the battery module 60 at night when the power demand would typically be low, put power onto the grid 14 during the day if the battery module 60 is fully charged and the array 40 and the wind turbine 50 are able to provide power to exceed the power demand, use the power from the batteries on the electric vehicles 20 coupled to the charging stations 12 if power is need for the grid 14 for frequency and voltage stability purposes or otherwise, etc.

The controller 66 can prioritize and optimize which one or more of the power sources will be providing power to the bus 28 for powering the charging stations 12 for cost and efficiency purposes. In one non-limiting embodiment, as mentioned above, the controller 66 will control the PCSs 24, 44 and 52 to prioritize use of power from the power sources by first using power from the solar array 40, then using power from the wind turbine 50 if the array 40 cannot meet the power demand, then using power from the battery module 60 if the array 40 and the turbine 50 cannot meet the power demand, then using power from the grid 14 if the array 40, the wind turbine 50 and the battery module 60 cannot meet the power demand, and then using the back-up generator 56 as is necessary.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A power distribution network comprising:
a DC bus;
a plurality of power sources electrically coupled to the DC bus;
a DC-to-AC power conversion system (PCS) coupled to the DC bus and an AC utility feed line that is part of a utility grid;
a plurality of loads electrically coupled to the DC bus; and
a network controller that controls the network, said controller controlling which of the power sources and the utility grid provides power to the loads in response to a power demand from the loads and the available power from the power sources and the grid.

2. The network according to claim 1 wherein the plurality of power sources include at least one renewable energy power source and at least one energy storage device.

3. The network according to claim 2 wherein the plurality of power sources include a battery module, a solar panel array and a wind turbine.

4. The network according to claim 2 further comprising a DC-to-DC PCS coupled to the at least one renewable energy power source and the DC bus, said controller prioritizing which of the at least one renewable energy power source, the energy storage device and the grid provide power to the loads by controlling the DC-to-DC PCS and the DC-to-AC PCS.

5. The network according to claim 4 wherein the controller first causes the at least one renewable energy power source to provide power to the loads, then causes the energy storage device to provide power to the loads if the at least one renewable energy power source cannot meet the power demand, and then causes the grid to provide power to the loads if the at least one renewable energy power source and the energy storage device cannot meet the power demand.

6. The network according to claim 5 wherein one of the plurality of power sources is a back-up generator, and wherein the controller causes the back-up generator to provide power to the loads if the at least one renewable energy power source, the energy storage device and the grid cannot meet the power demand.

7. The network according to claim 5 wherein the at least one renewable energy power source is an array of photovoltaic (PV) cells and/or a wind turbine.

8. The network according to claim 1 wherein the plurality of loads are electric vehicle charging stations.

9. The network according to claim 1 wherein the controller controls the plurality of power sources to provide frequency regulation and voltage support of power signals on the grid.

10. The network according to claim 1 wherein the plurality of power sources and the plurality of loads are in a same general area.

11. A power distribution network comprising:
a DC bus;
a plurality of power sources electrically coupled to the DC bus, said power sources including an array of photovoltaic (PV) cells, a wind turbine and an energy storage device;
a DC-to-AC power conversion system (PCS) coupled to the DC bus and an AC utility feed line that is part of a utility grid;
a plurality of electric vehicle (EV) charging stations electrically coupled to the DC bus; and
a network controller that controls the network, said controller controlling which of the power sources and the utility grid provides power to the charging stations in response to a power demand from the charging stations and the available power from the power sources and the grid.

12. The network according to claim 11 further comprising a DC-to-DC PCS coupled to the array of PV cells and the DC bus and a DC-to-DC PCS coupled to the wind turbine and the DC bus, said controller prioritizing which of the array of PV cells, the wind turbine, the energy storage device and the grid provide power to the charging stations by controlling the DC-to-DC PCSs and the DC-to-AC PCS.

13. The network according to claim 12 wherein the controller first causes the array of PV cells to provide power to the charging stations, then causes the wind turbine to provide power to the charging stations if the array of PV cells cannot meet the power demand, then causes the energy storage device to provide power to the charging stations if the array of PV cells and the wind turbine cannot meet the power demand, and then causes the grid to provide power to the charging stations if the array of PV cells, the wind turbine and the energy storage device cannot meet the power demand.

14. The network according to claim 13 wherein the plurality of power sources includes a back-up generator, and wherein the controller causes the back-up generator to provide power to the charging stations if the array of PV cells, the wind turbine, the energy storage device and the grid cannot meet the power demand.

15. The network according to claim 11 wherein the controller controls the plurality of power sources to provide frequency regulation and voltage support of power signals on the grid.

16. The network according to claim 11 wherein the plurality of power sources and the charging stations are in a same general area.

17. The network according to claim 11 wherein the energy storage device is a battery module.

18. The network according to claim 11 wherein the controller controls the charging stations so as to provide power from batteries on the electric vehicles coupled to the charging stations to the grid.

19. A power distribution network comprising:
a DC bus;
a plurality of power sources electrically coupled to the DC bus, wherein the plurality of power sources include at least one renewable energy power source and at least one energy storage device;
a DC-to-AC power conversion system (PCS) coupled to the DC bus and an AC utility feed line that is part of a utility grid;
a DC-to-DC PCS coupled to the DC bus and the at least one renewable energy power source;
a plurality of loads electrically coupled to the DC bus; and
a network controller that controls the network, said controller controlling which of the power sources and the utility grid provides power to the loads in response to a power demand from the loads and the available power from the power sources and the grid, wherein the controller first causes the at least one renewable energy power source to provide power to the loads, then causes the energy storage device to provide power to the loads if the at least one renewable energy power source cannot meet the power demand, and then causes the grid to provide power to the loads if the at least one renewable energy power source and the energy storage device cannot meet the power demand.

20. The network according to claim 19 wherein the plurality of loads are electric vehicle charging stations.
